(19) United States
(12) Patent Application Publication
(10) Pub. No.: US 2022/0405491 A1
(43) Pub. Date: Dec. 22, 2022

(54) CENTRALIZED TASK DISSIMINATION WITH TRANSLATION

(71) Applicant: Microsoft Technology Licensing, LLC, Redmond, WA (US)

(72) Inventors: Andrew FRIEDMAN, Phoenix, AZ (US); Natasha PEREREZOVA, Redmond, WA (US); Dirk GULLENTOPS, Mechelen (BE); Mahesh PASUPULETI, Union City, CA (US); Preethi RAMANA, Fremont, CA (US)

(73) Assignee: Microsoft Technology Licensing, LLC, Redmond, WA (US)

(21) Appl. No.: 17/353,910

(22) Filed: Jun. 22, 2021

(51) Int. Cl. G06F 40/58; G06F 40/263; G06Q 10/06; G06F 3/0482

(52) U.S. Cl. CPC G06F 40/58; G06F 40/263; G06Q 10/06311; G06F 3/0482

(57) ABSTRACT

A task comprising content specified in a first language at a first location associated with an organization is received at a task application associated with a second location of the organization. The task specifies work to be performed at the second location associated with the organization. In response to determining that the first language is different from a second language preferred by a task recipient at the second location of the organization, translation of at least a portion of content of the task from the first language into the second language is automatically obtained by the task application. At least the portion of the content of the task translated to the second language is then displayed to the task recipient in a user interface of the task application.

### BACKGROUND

Organizations, such as retail organizations, healthcare organizations, manufacturing organizations and the like, rely on front line workers, such as store, hospital or factory employees to provide consistent and repeatable products and services. Such organizations sometimes utilize tasks or workflows that may be defined at a central location of the organization, such as a central office or a headquarters of the organization, and may be disseminated to non-central locations, such as retail stores, hospitals or factories, where the tasks or workflows may be implemented by front line workers of the organization. Some organizations have front line locations across multiple geographical areas where front line workers may use languages that are different from a language generally spoken at the central office or headquarters of the organization. In such situations, a task or a workflow may be defined in a language that is different from a language of the front line worker who is to implement the task or the workflow at the front line location of the organization. Such language discrepancy may result in inefficiencies in task or workflow implementation and/or may result in incorrect task or workflow implementation.

It is with respect to these and other general considerations that the aspects disclosed herein have been made. Also, although relatively specific problems may be discussed, it should be understood that the examples should not be limited to solving the specific problems identified in the background or elsewhere in this disclosure.

### SUMMARY

In accordance with examples of the present disclosure, a task application allows workers at a central location of an organization to generate tasks or workflows to be implemented at front line locations of the organization, and to disseminate the tasks or workflows to a plurality of front line locations of the organization. The tasks or workflows may be defined in a first language, such as a language generally spoken at the central location of the organization. In an aspect, when a recipient user accesses and views a task via the recipient's task application, at least a portion of content of the task may be displayed to the recipient user in a second language that is different from the first language. For example, at least a portion of the content of the task may be displayed to the recipient user in a language that is generally spoken in a geographical area of the front line location that employs the recipient user. In aspects, translation at least a portion of content of the task may be performed automatically and transparently to both the originator and the recipient of the task. For example, the task application may automatically detect the language of the content of the task, determine (e.g., based on a user or an organization profile stored in a database) a preferred language of the recipient of the task, and obtain a translation of at least a portion of the content of the task from the first language to the second language, where the translation may be performed by a suitable translation service, such as a translation service that employs a machine learning (ML) model, translation libraries, etc. These and other techniques described herein provide more efficient and flexible ways for central offices to define a set of work for a diverse, multi-lingual workforce. For example, automatic translation of tasks may enable an organization to ensure that front line users can see the tasks in their preferred language, without additional work by the organization.

In aspects, a system is provided. The system includes one or more computer readable storage media and program instructions stored on the one or more computer readable storage media that, when executed by at least one processor, cause the at least one processor to perform operations. The operations include receiving electronic data defining a task that specifies work to be performed at a second location associated with an organization, the electronic data comprising task content specified in a first language at a first location associated with the organization, the electronic data having been transmitted over a communication network. The operations also include determining that the first language in which the task content was specified at the first location is different from a second language associated with a recipient of the task at the second location. The operations also include, in response to determining that the first language is different from the second language, obtaining, using an electronic translation engine, translation of at least a portion of the task content from the first language into the second language. The operations further include causing the at least the portion of the task content translated to the second language to be displayed to the recipient.

In further aspects, a method is provided. The method includes receiving user input provided by a task originator associated with a first location of an organization, wherein the user input specifies content of one or more tasks defining work to be performed at a plurality of second locations of the organization. The method also includes generating electronic data defining the one or more tasks, wherein the electronic data includes the content of the one or more tasks in a first language associated with the first location of the organization. The method further includes causing the electronic data defining the one or more tasks to be transmitted, over a communication network, to respective user devices of a plurality of recipient users associated with the plurality of second locations. The plurality of second locations include a particular location associated with a second language different from the first language. At least a portion of content of the one or more tasks is to be displayed to a first recipient user, associated with the particular second location, in the second language different from the first language.

In still further aspects, a computer storage medium is provided. The computer storage medium stores computer-executable instructions that when executed by at least one processor cause a computer system to perform operations. The operations include receiving electronic data defining a task that specifies work to be performed at a second location associated with an organization, the electronic data comprising task content specified in a first language at a first location associated with the organization, the electronic data having been transmitted over a communication network. The operations also include determining that the first language in which the task content was specified at the first location is different from a second language associated with a recipient of the task at the second location. The operations additionally include, in response to determining that the first language is different from the second language, obtaining, using an electronic translation engine, translation of at least a portion of the task content from the first language into the second language. The operations further include causing the at least the portion of the task content translated to the second language to be displayed to the recipient.

This Summary is provided to introduce a selection of concepts in a simplified form, which is further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the following description and, in part, will be apparent from the description, or may be learned by practice of the disclosure.

### BRIEF DESCRIPTION OF THE DRAWINGS

Non-limiting and non-exhaustive examples are described with reference to the following Figures.

FIG. 1 is a block diagram of a system in which task translation may be performed to automatically translate tasks from a language in which the tasks are defined to a language associated with recipients of the tasks, in accordance with an aspects of the present disclosure.

FIG. 2 depicts an example of a task list that may be generated at a central location of an organization, in accordance with aspects of the present disclosure.

FIG. 3 depicts a task that may be generated at a central location for dissemination to one or more non-central locations, in accordance with aspects of the present disclosure.

FIGS. 4A-B depict dissemination of a task list from a central location to one or more non-central locations, in accordance with aspects of the present disclosure.

FIG. 5 depicts a task that is translated from a language in which the tasks are defined to a language associated with recipients of the tasks, in accordance with aspects of the present disclosure.

FIGS. 6A-C depicts tasks that are translated from a language in which the tasks are defined to a language associated with recipients of the tasks, in accordance with aspects of the present disclosure.

FIG. 7 depicts details of a method for task translation, in accordance with aspects of the present disclosure.

FIG. 8 is a block diagram illustrating physical components (e.g., hardware) of a computing device with which aspects of the disclosure may be practiced.

FIGS. 9A-9B illustrate a mobile computing device with which aspects of the disclosure may be practiced.

### DETAILED DESCRIPTION

In the following detailed description, references are made to the accompanying drawings that form a part hereof, and in which are shown by way of illustrations specific aspects or examples. These aspects may be combined, other aspects may be utilized, and structural changes may be made without departing from the present disclosure. Aspects disclosed herein may be practiced as methods, systems, or devices. Accordingly, embodiments may take the form of a hardware implementation, an entirely software implementation, or an implementation combining software and hardware aspects. The following detailed description is therefore not to be taken in a limiting sense, and the scope of the present disclosure is defined by the appended claims and their equivalents.

In accordance with examples of the present disclosure, a task application allows workers at a central location of an organization to generate tasks or workflows to be implemented at front line locations of the organization, and to disseminate the tasks or workflows to a plurality of front line locations of the organization. The tasks or workflows may be defined in a first language, such as a language generally spoken at the central location of the organization. In an aspect, when a recipient user accesses and views a task via the recipient's task application, at least a portion of content of the task may be displayed to the recipient user in a second language that is different from the first language. For example, at least a portion of the content of the task may be displayed to the recipient user in a language that is generally spoken in a geographical area of the front line location that employs the recipient user. In aspects, translation of at least a portion of the content of the task may be performed automatically and transparently to both the originator and the recipient of the task. For example, the task application may automatically detect the language of the content of the task, determine (e.g., based on a user or an organization profile stored in a database) a preferred language of a recipient of the task, and obtain a translation of the at least a portion of the content of the task from the first language to the second language, where the translation may be performed by a suitable translation service, such as a translation service that employs a machine learning (ML) model, translation libraries, etc. These and other techniques described herein provide more efficient and flexible ways for central offices to define a set of work for a diverse, multi-lingual workforce. For example, automatic translation of tasks may enable an organization to ensure that front line users can see the tasks in their preferred language, without additional work by the organization.

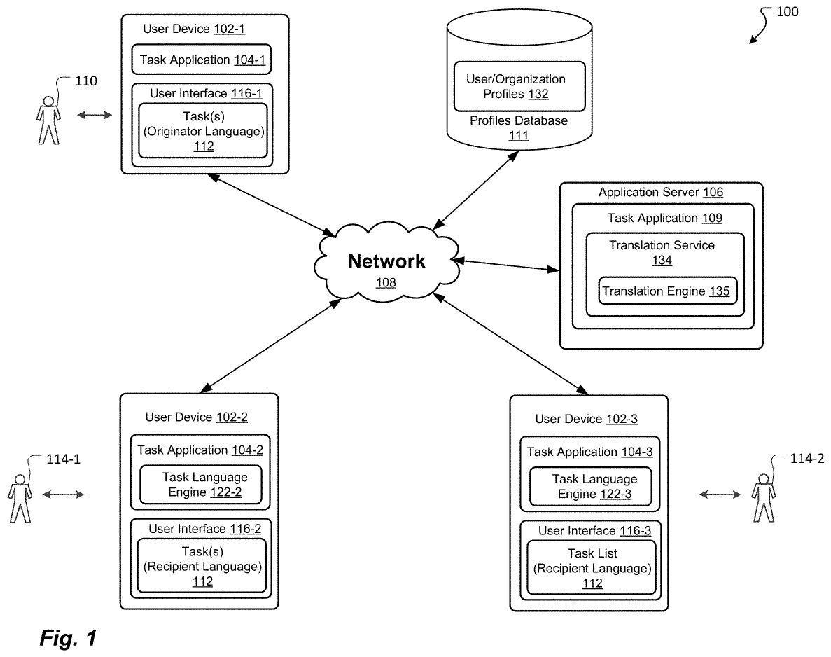

FIG. 1 illustrates an overview of an example system 100 in which task publishing and translation techniques may be utilized, in accordance with aspects of the present disclosure. The system 100 may include a plurality of user devices 102 that may be configured to run or otherwise execute client applications 104. The user devices 102 may include, but are not limited to, laptops, tablets, smartphones, and the like. The applications 104 may include client applications having task publishing features (“task client applications”). The task client applications 104 may be installed in and/or executing as part of meeting applications; non-limiting examples of such meeting applications include, but not limited to, conferencing applications, workflow applications, customer relationship management applications, collaboration platforms, etc. In other examples, the task client applications 104 may be standalone task applications. In some examples, the task client applications 104 may include web applications, where such applications 104 may run or otherwise execute instructions within web browsers. In some examples, the task client applications 104 may additionally or alternatively include native client applications residing on the user devices 102.

The user devices 102 may be communicatively coupled to an application server 106 via a communication network 108. The application server 106 may be configured to run or otherwise execute a server task application 109. The communication network 108 may be a wide area network (WAN) such as the Internet, a local area network (LAN), or any other suit able type of network. The communication network 108 may be single network or may be made up of multiple different networks, in some examples. The task client applications 104 may allow users 110 associated with a central location of an organization to define tasks specifying work that needs to be performed at non-central (e.g. front line) locations of the organization, to publish or otherwise disseminate the tasks to the non-central locations, to monitor progress of work performed on the tasks at the non-central locations, etc. The task client applications 104 may also allow users 110 at non-central locations to view tasks published to the non-central locations, to assign the tasks to be performed by workers at the non-central locations, to update status of work performed at the non-central locations, etc.

With continued reference to FIG. 1, the system 100 may include a profiles database 111. The profiles database 111 may be communicatively coupled to the application server 106 and/or to the one or more user devices 102 via the communication network 108, as illustrated in FIG. 1, or may be coupled to the application server 106 and/or to the one or more user devices 102 in other suitable manners. For example, the profiles database 111 may be directly connected to the meeting application server 106, or may be included as part of the meeting application server 106, in some examples. The profiles database 111 may be a single database or may include multiple different databases.

In some aspects, a first user 110 of a first task client application 104 may define a set of tasks in a first language that may be a preferred language of the first user 110 using the first task client application 104. The set of tasks may be disseminated to be viewed, managed, etc., by one or more second users 114 via one or more second task client applications 104, where the one or more second users 114 may include users who may prefer one or more second languages different from the first language preferred by the first user 110. As just an example, the first user 110 may be associated with a central location (e.g., a central office or headquarters) of an organization, and may define the set of tasks in a first language that is generally spoken in a geographical area of the central location of the organization. The set of tasks may then be disseminated to users 114 associated with one or more non-central locations (e.g., front line locations such as retail stores, healthcare locations (such as clinics, hospitals, and the like), factories, etc.) of the organization that may be located in one or more geographical areas in which generally spoken second languages may be different from the first language of the geographical area of the central location of the organization.

In some aspects, the system 100 may support automatic task generation in which tasks specifying work to be performed may be generated automatically, e.g., by the server task application 109 in response to receiving a request via the communication network 108. Such request may be received, for example, from a customer user device (e.g., laptop, tablet, smartphones, and the like), for example when a customer places a curb side pick order to be picked up at a particular store location of a retail organization. As another example, such request may be received from a sensor device, such as a sensor device that may be installed on a shelf in a store location and may transmit, via the communication network 108, an indication to the server task application 109 that the shelf may need to be re-socked at the store location. In response to receiving such requests or indications, the server task application 109 may automatically generate corresponding tasks and provide the generated tasks to users at the front line (e.g., store) locations of the organization. The tasks automatically generated by the server task application 109 may be defined in a first language, such as the language generally spoken in the geographical area of the central location of the organization, regardless of language preferred by recipients of the tasks, such as language generally spoken in geographical areas of the front line locations of the organization.

In aspects, content of the tasks defined in the first language may be translated in the system 100 from the first language into one or more second languages, and may be displayed to respective recipients of the tasks in the one or more second languages. Translation of the task content may be performed in the system 100 automatically and transparently to the originators and the recipients of the tasks. In this way, tasks that are defined in a first language, such as a language generally spoken in a geographical location of a central office or headquarters of an organization, may be disseminated to one or more front line workers in non-central locations (e.g., retail stores, clinics, hospitals, factories, etc.) of the organization, and may be displayed to the one or more front line workers in respective languages that may be generally spoken in geographical areas of the one or more non-central locations of the organization. Thus, workers in the central office or the headquarters of the organization may easily reach a multi-lingual workforce of front line locations of the organization, which may facilitate consistent task implementation across the front line locations in different geographical areas, for example.

With continued reference to FIG. 1, in an example scenario, a user 110 may use a task client application 104-1, executing or otherwise running on a user device 102-1, to define one or more tasks 112 (sometimes referred to herein as “tasks 112” for brevity). The tasks 112 may then disseminated to one or more users 114 and may be accessed. by the one or more users 114 via respective one or more task client applications 104 executing on user devices 102 of the one or more users 114. The user 110 who defines the tasks 112 is sometimes referred to herein as an “originator user 110,” and the task client application 104-1 used by the originator user 110 to define the asks 112 is sometimes referred to herein as an “originator's task client application 104-1.” Similarly, a user 114 who receives and accesses the tasks 112 is sometimes referred to herein as a “recipient user 114,” and a task client application 104 used by a recipient user 114 to access the tasks 112 is sometimes referred to as a “recipient's task client application 104.” Although for exemplary purposes the system 100 is illustrated in FIG. 1 as including one user device 102-1 associated with one task originator user 110 and two user device 102-2 and 102-3 respectively associated with two recipient users 114-1 and 114-2, in some aspects the one or more tasks 112 may be defined by multiple originator users 110 using respective ones of multiple users devices 102 and/or may be disseminated to, and accessed by, more than two recipient users 114 via respective user devices 102 of the more than two recipient users 114. For example, in some aspects, the tasks 112 may be defined by one or more originator users 110 associated with a central location of an organization, and may disseminated to, and accessed by, recipient users 114 across tens, hundreds, thousands, etc., of front line locations of the organization. In another aspect, the tasks 112 may be disseminated to, and accessed by, only a single recipient user 114.

In an aspect, the originator user 110 may be, for example, a member of operations or communications (e.g., retail communications) team at a central office or a headquarters of the organization, and the originator user 110 may define the tasks 112 to specify work to be performed at one or more front line locations (e.g., retail stores) of the organization. In aspects, to define a task 112, the originator user 110 may input, via a user interface 116-1 of the originator's task client application 104-1, content of the task 112, such as a title defining the task 112 (e.g., “create a merchandizing display” or “reduce prices of frozen good items”), a priority (e.g., low, medium, high, etc.) of the task 112, a start date and/or a due date for implementing the task 112, notes and/or a checklist for completion of the task 112, etc. The originator user 110 may enter the content of the task in a first language, such as a language generally spoken in a geographical area of the central location of the organization or a language otherwise preferred by the originator user 110.

The tasks 112 defined by the originator user 110 may then be published or otherwise disseminated to the one or more recipient users 114 who may be associated with the one or more front line locations of the organization. In an aspect, electronic data defining the tasks 112 may be transmitted, over the communication network 108, to the application server 106 and/or one or more user devices 102 of the one or more users 114. The electronic data may define various fields that may be included in the tasks 112 and may include content of the various fields of the tasks 112. In an aspect, the originator user 110 may specify, via the user interface 116-1 of the task client application 104-1, the one or more non-central locations to which the list of one or more tasks is to be disseminated. The recipient users 114 may be, for example, managers or workers at the one or more non-central locations of the organization. The recipient users 114 may view, manage etc., the tasks 112 via respective user devices 102 (e.g., the user device 102-2 and the user device 102-3) of the recipient users 114. In aspects, the one or more non-central locations may include at least one location in a geographical area in which a generally spoken language is different from the first language in which the tasks 112 were defined by the originator user 110. As just an example, whereas the tasks 112 may be defined by the originator user 110 in English, the one or more non-central locations may include at least one location in a geographical area in which the generally spoken language is Spanish. Of course, in other aspects, the tasks 112 may be defined by the originator user 110 in a language other than English and/or the one or more non-central locations may include locations in one or more geographical areas in which the generally spoken languages include languages other than Spanish.

With continued reference to FIG. 1, the one or more recipient users 114 may access the tasks 112 via user interfaces 116 of respective recipient's task client applications 104. Respective recipient users 114 may be associated with respective non-central locations (e.g., front line locations) of the organization. For example, a first recipient user 114-1 may be a manager or a worker at a first retail store of the organization and a second recipient user 114-2 may be a manager or a worker at a second retail store of the organization. In another aspect, the first recipient user 114-1 and the second recipient user 114-2 may be associated with a same non-central location of the organization, such as a same retail store of the organization.

In some aspects, the recipient users 114 may include users who have preferred languages that are different from the first language in which the tasks 112 were defined by the originator user 110. For example, in an aspect, the non-central location of the organization may be located in a geographical area in which a language generally spoken is different from the language generally spoken in the geographical area of the central location of the organization. In an aspect, when a recipient user 114 accesses the tasks 112 via the user interface 116 of the recipient's client application 104, the recipient's client application 104 may display, to the recipient user 114, translation of the tasks 112 (e.g., translation of at least a portion of the content of the tasks 112) from the first language in which the tasks 112 were defined by the originator user 110 to the preferred language of the recipient users 114. For example, the recipient's client application 104 may display, to the recipient user 114, translation of the tasks 112 from the language generally spoken in the geographical area of the central location of the organization into the language generally spoken in the geographical area of the non-central location of the organization.

In aspects, translation of the tasks 112 from the first language in which the tasks 112 were defined by the originator user 110 to the second language that is the preferred language of the intended recipient user 114 is performed automatically and transparently to the originator user 110 and the recipient user 114. In an example, the recipient's client application 104 may include a task language engine 122 configured to initiate translation of tasks 112 when the tasks 112 are being accessed by the recipient user 114. In another example, the translation is initiated by the originator's client application 104 prior to dissemination of the tasks 112 to the recipient user 114. In yet another example, the translation is performed automatically by the server task application 109. While the task language engine 122 is illustrated as being executed by a recipient's client application 104, the task language engine 122 may be at least partially executed at an originator's task client application 104 and/or the task server application 109.

The task language engine 122 may be configured to determine that the first language in which a task 112 are defined by the originator user 110 is different from the second language that is the preferred language of the recipient user 114. In an aspect, the task language engine 122 may automatically detect the first language in which the task 112 is defined, and may determine a preferred language of the user 114 based on a preferred language setting that may be stored in association with the recipient user 114 and/or with a front line location associated with the recipient user 114, for example in a user and/or organization profile 132 that may be stored in the profiles database 111. In an aspect, the preferred language settings in user and/or organization profiles 132 are controlled by an administrator of the organization. In some aspects, the administrator may also enable or disable translation for particular users, teams, locations, etc., of the organization. In such manners, the administrators may appropriately configure task translations preferred or desired by the organization. In some aspects, individual users, teams, locations, etc. may additionally or alternatively control the translation settings in the user and/or organization profiles 132.

In an aspect, if the preferred language of the user 114 is a second language that does not match the first language in which the task 112 is defined, and, in some aspects, if translation services are enabled for the user 114, the task language engine 122 may initiate translation of content of the task 112 from the first language into the second language. For example, the task language engine 122 may parse out one or more text strings from the task 112 and may cause the one or more text strings to be transmitted to a translation service 134. In an aspect, the translation service 134 may be hosted on (e.g., may reside or otherwise execute on) the application server 106. For example, the translation service 134 may be bundled with the task sever application 109 on the application server 106. Using a translation service that is bundled with the task sever application 109 ensures that the task content is translated in a secure manner within security and compliance boundaries that may be set up for the tenant associated with the organization by the task sever application 109. In other aspects, however, the translation service 134 may be a publicly hosted translation service, for example if the organization does not require or desire added security and/or compliance features offered by the task sever application 109.

In an aspect, the translation service 134 may comprise an electronic translation engine 135 configured to utilize a corpus of information to perform translation of the text strings provided to the translation service 134. In some aspects, the electronic translation engine 135 include a machine learning model trained to perform translations. In other aspects, other suitable translation techniques may be utilized. In some aspects, the corpus of information used by the electronic translation engine 135 may be a corpus that is shared among multiple organizations that may utilize the translation service 134 for translation of task content published to non-central locations of the multiple organizations. In another aspect, the translation service 134 may utilize one or more organization-specific libraries that may be provided by, or generated for, a particular organization that utilizes the translation service 134 for task content translation. As an example, in an aspect in which the organization is a healthcare organization, the translation service 134 may utilize one or more healthcare-specific translation libraries, instead of or in addition to a general corpus of information, to provide better translation of task content that may be specific to the healthcare organization. In some examples, the translation service 134 may access organization-specific configuration information that may be stored, for example, in an organization profile 132 in the database 111, to enhance translation of task content performed for the organization. For example, the organization-specific configuration information may specify certain terms (e.g., general medical terms or organization-specific terms) that should be kept in the original language in the translation.

The translation service 134 may return translated text strings to the recipient's client application 104. The recipient's client application 104 may populate corresponding fields in the task 112 with the translated strings provided by the translation service 134. Thus, content of the task 112 may be presented to the recipient user 114 in the language that is preferred by the recipient 114 regardless of the language in which the task was originally defined in the system 100. In some aspects, the recipient's client application 104 may additionally allow the user 114 to view the task 112 in the original language in which the task 112 was defined, for example by providing a toggle button that allows the user 114 to toggle between the first language and the second language. In such ways, content of the tasks may be effectively communicated across a multi-lingual workforce of an organization, where respective users may view tasks, defined in a language of a central location of the organization, in respective preferred languages of the respective users within the organization.

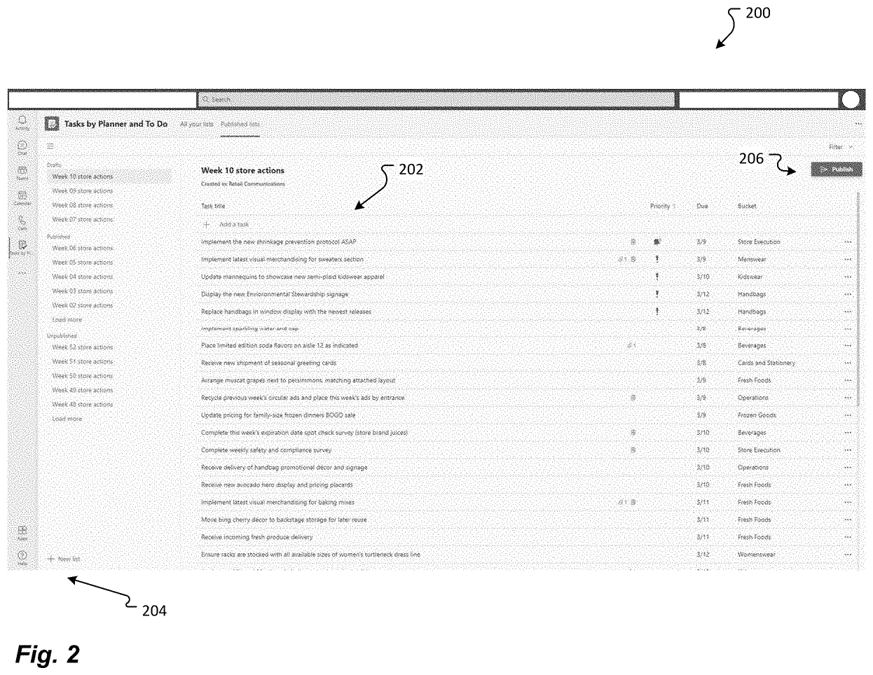

Turning now to FIG. 2, a task list 212 is depicted as being displayed in a user interface 202 of an application 204, in accordance with examples of the present disclosure. In an aspect, the application 204 may correspond to an application 104 (e.g., the originator's task client application 104-1) of the system 100 of FIG. 1. The task list 212 may correspond to, or may include, the tasks 112 defined by the originator user 110 of FIG. 1. For ease of explanation, the task list 212 is described with reference to FIG. 1. In another example, the task list 212 may be created in a system different from the system 100 of FIG. 1.

The task list 200 includes a plurality of tasks 202. The tasks 202 may correspond to tasks 112 of FIG. 1. The user 110 may be a member of a retail communications team in a central office of an organization, for example. The user 110 may create the task list 200 by clicking on, or otherwise engaging with, a “new list” icon 204 that may be displayed in the user interface 202. Clicking on or otherwise engaging with the “new list” icon 204 may allow the originator user 110 to enter a name of the task list 200. In an aspect, clicking on or otherwise engaging with the “new list” icon 204 may allow the user 110 to enter a team name (e.g., retail communication) to enable a recipient of the task list 200 a team that originated the task list 200. Upon creating a new task list, the user 110 may add one or more tasks 202 to the task list 200.

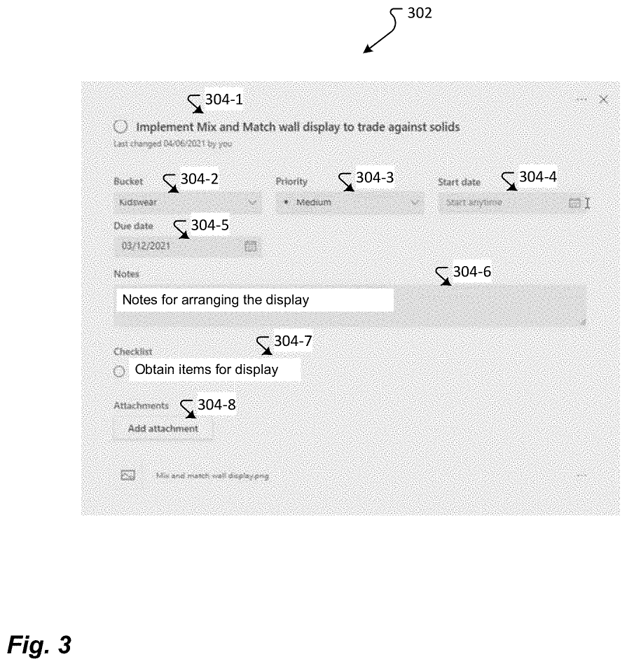

FIG. 3 depicts a task 302 that may be displayed in a user interface of an originator's task client application, in accordance with aspects of the present disclosure. The task 302 may correspond to a task 202 in the task list 212 of FIG. 2. The task 302 may include a plurality of fields 304, including a title field 304-1, a bucket field 304-2, a priority field 304-3, a start date field 304-4, a due date field 304-5, a notes field 304-6, a checklist field 304-7 and an attachment field 304-8. In some aspects, the task 302 may omit one or more of the fields 304 illustrated in FIG. 3 and/or may include one or more additional fields 304 not illustrated in FIG. 3. The title field 304-1 may allow the user 110 to enter a descriptive title for the task 302 (e.g., “Implement Mix and Match wall display to trade against solids” in the illustrated example). The bucket field 304-2 may allow the user 110 to provide a bucket for the task 302 (e.g., “kidswear” in the illustrated example), for example to inform the recipient of the task 302 of the area of work into which the task 302 has been pre-organized. The priority field 304-3 allows the user 110 to set a priority for the task 302. For example, the priority field 304-3 may allow the user 110 to select a priority from among a set of predetermined priorities, such as “low”, “medium” or “high”. The start date field 304-4 may allow the user 110 to set a start date for implementation of the task 302, such as “start any time” or a specific date indicating when implementation of the task 302 may be initiated. The due date field 304-5 may allow the user 110 to specify a date by which completion of the task 302 is expected. The notes field 304-6 may allow the user 110 to enter notes that may be useful for implementation of the task 302, for example. The checklist list field 304-7 may allow the user 110 to provide a list of one or more items, for example defining steps that may need to be performed to implement the task 302. The attachment field 304-8 may allow the user 110 to include an attachment, such as an image or a document. In aspects, the user 110 may populate some or all of the fields 304 to define the task 302. Content of the fields 304 may be entered by the user 110 in a first language that may be preferred by the user 110. As an example, content of the fields 304 may be entered by the user 110 in a first language that is generally spoken in a geographical area of the central location of the organization of which the user 110 may be a part.

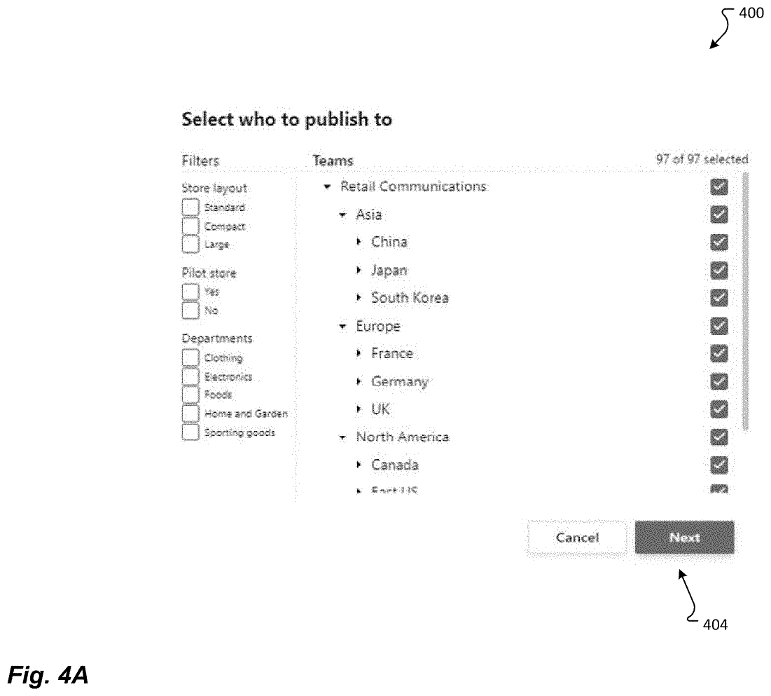

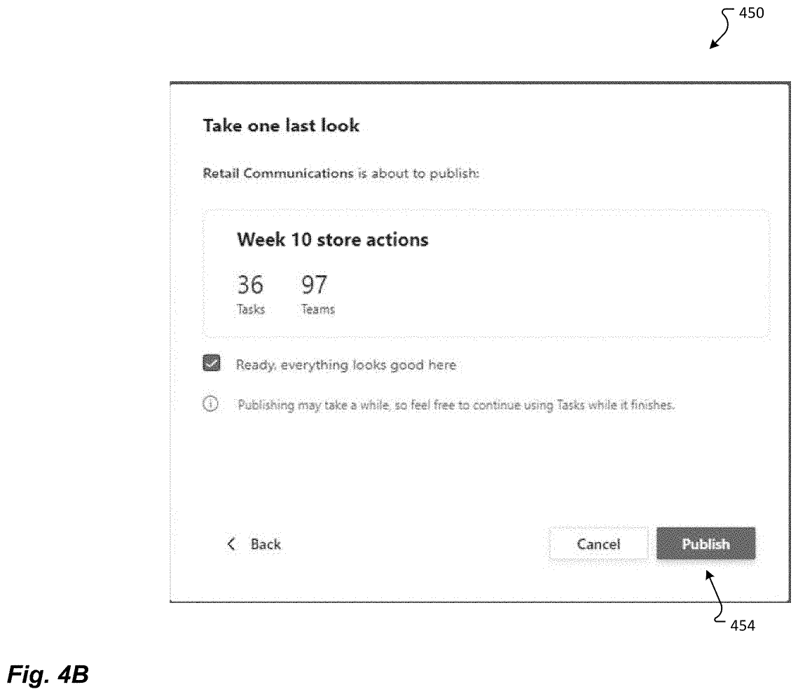

Referring back to FIG. 2, upon defining one or more tasks 202, which may include one or more tasks such as the task 302, to be included in the task list 212, the user 110 may choose to publish the task list 212 to one or more non-central locations of the organization. The user 110 may initiate publishing of the task list 212 by clicking on, or otherwise engaging, with a “publish” icon 206 that may be displayed on the user interface 202. Referring briefly to FIG. 4A, clicking on or otherwise engaging with the publish icon 206 may bring up a user interface 400 that may allow the user 110 to select one or more specific locations for publishing of the task list 212. As illustrated in FIG. 4A, the one or more specific locations that may be selected by the user 110 may be different geographical areas, such as areas in one or more of i) Asia (e.g., China, Japan, South Korea, etc.), ii) Europe (e.g. France, Germany, UK, etc.), iii) North America (e.g., Canada, East United states, etc.), and so on.

In examples, the user 110 may select to publish the task list 212 to all or some of the non-central locations that may be displayed to the user 110 via the user interface 400. Upon making the selection(s), the user 110 may click on or otherwise engage with a “Next” button 404 that may be displayed to the user 110 in the user interface 400. Referring now to FIG. 4B, in an aspect, clicking or otherwise engaging with the next button 404 may bring up a user interface 450 that may allow the user 110 to review selections and publish the task list 212 to teams in the one or more non-central locations selected by the user 110. In aspects, the user interface 450 may display various information that may be relevant to publishing the task list 212 to the teams at the one or more non-central locations selected by the user 110, such as the number of tasks in the task list 212 and/or the number of teams selected by the user 110 for publishing the task list 212. In the illustrated example, the user interface 450 is depicted as displaying information indicating thirty six tasks in the task list 212 are to be published to each of ninety seven teams selected by the user 110. Of course, generally any suitable number of tasks may be published to any suitable number of teams in other examples.

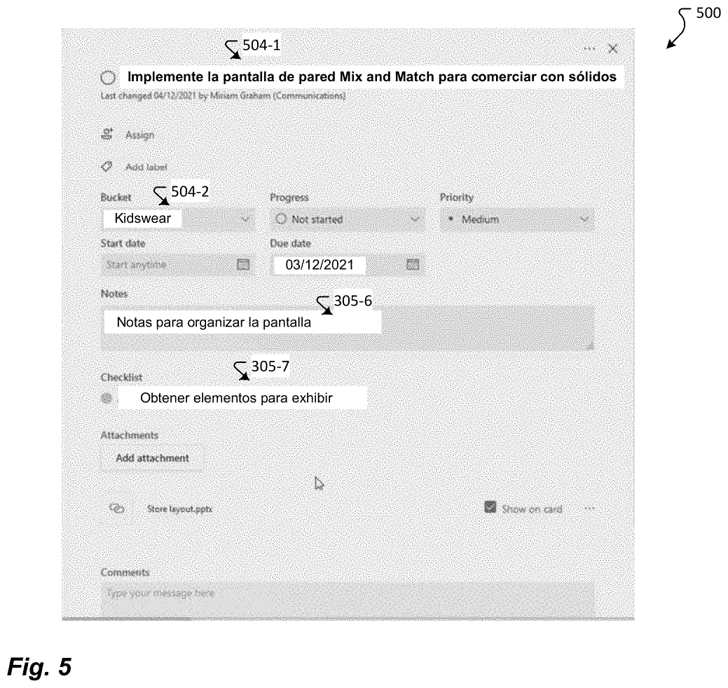

FIG. 5 depicts a task 502 that may be displayed in a user interface of a recipient's task client application, in accordance with aspects of the present disclosure. The task 502 may correspond to the task 302 of FIG. 3 with one or more fields translated from a first language (e.g., English) in which the task 302 was defined to a second language (e.g., Spanish) that may be a preferred language of the recipient of the task 302. As an example, the task 502 is depicted in FIG. 5 as including a title field 504-1 that includes a translation of content of the title field 304-1 of the task 302, a notes field 504-6 that includes a translation of the content of the notes field 304-6 of the task 302 and a checklist field 504-7 that includes translation of the content of the checklist field 304-7 of the task 302. In some aspects, the task 502 may include one or more fields that include non-translated (i.e., original language) content of the corresponding one or more fields of the task 302. As an example, the task 502 may additionally include a bucket field 504-2 which may correspond to the bucket field 304-2 and may include non-translated (i.e., original language) content of the bucket field 304-2.

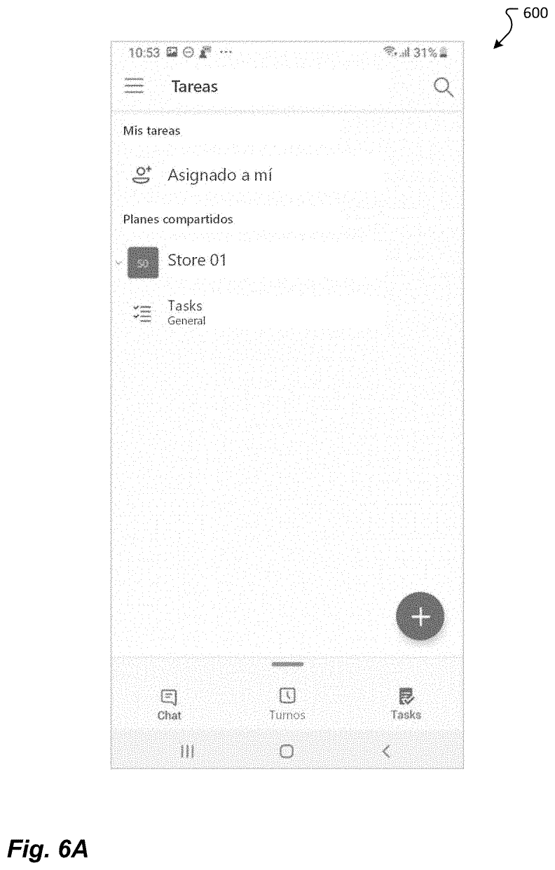

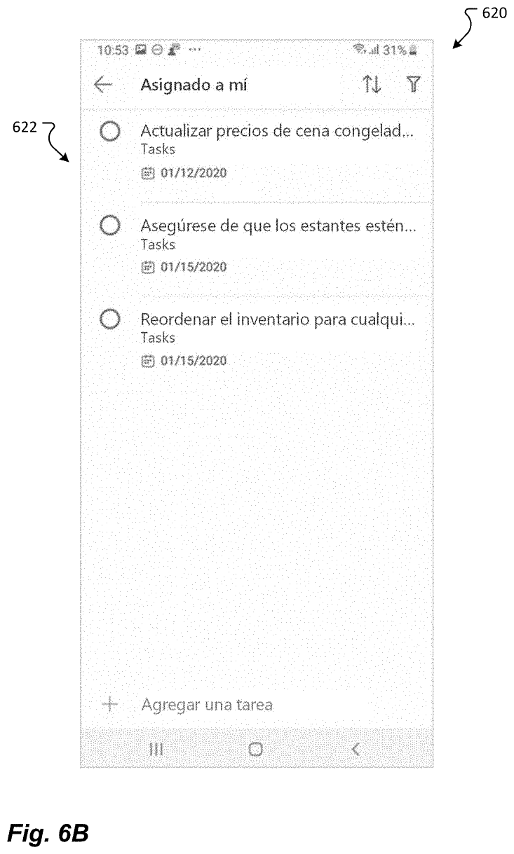

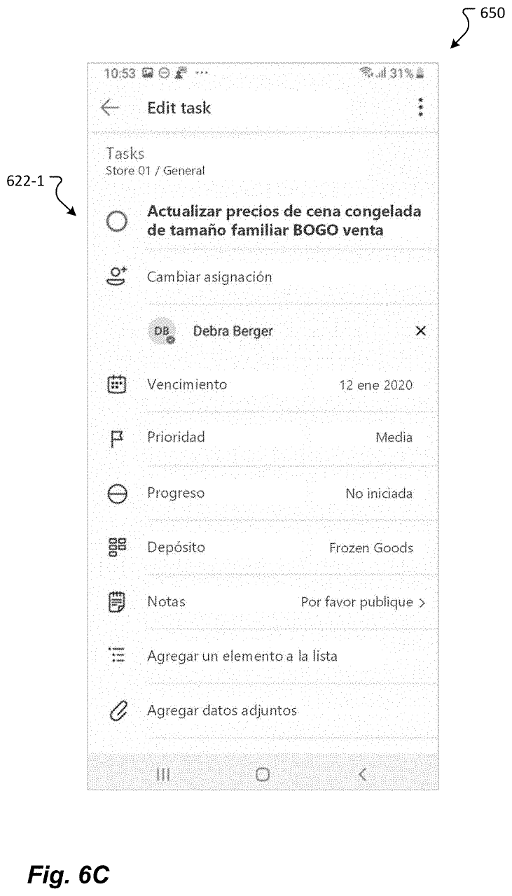

FIGS. 6A-C depict a set of user interfaces 600, 620, 650 displaying translations of at least a portion of content of received tasks 622 from a first language in which the tasks 622 were defined to a second language that may be a preferred language of the recipient of the tasks 622, in accordance with aspects of the present disclosure. The user interfaces 600, 620, 650 may be displayed on a user device (e.g., a mobile user device) of a front line worker of an organization to allow the front line worker to access and view tasks defined at a central location of the organization, for example. In an aspect, at least a portion of the content of the tasks that the user may access and view via the user interfaces 600, 620, 650 is displayed to the user in a second language (e.g., Spanish), whereas the tasks 622 were defined in a first language (e.g., English) different from the second language. For example, content of a predetermined set of one or more fields of each task 622 is displayed to the user is the second language (e.g., Spanish). In some aspects, content of one or more other fields of each task 622 is displayed to the user the first, original language (e.g., English). In an aspect, translation of at least a portion of the content of the tasks 622 that is displayed to the user in the second language is performed by the task language engine 122 and/or the translation service 121 as described above. In other aspects, translation of at least a portion of the content of the tasks 622 that is displayed to the user in the second language is performed in other suitable manners. In aspects, translation of the at least a portion of the content of the tasks 622 that is displayed to the user in the second language is performed automatically and transparently to the user who defined the tasks 622 in the first language and the user who is accessing and viewing the tasks 622 in the second language different from the first language.

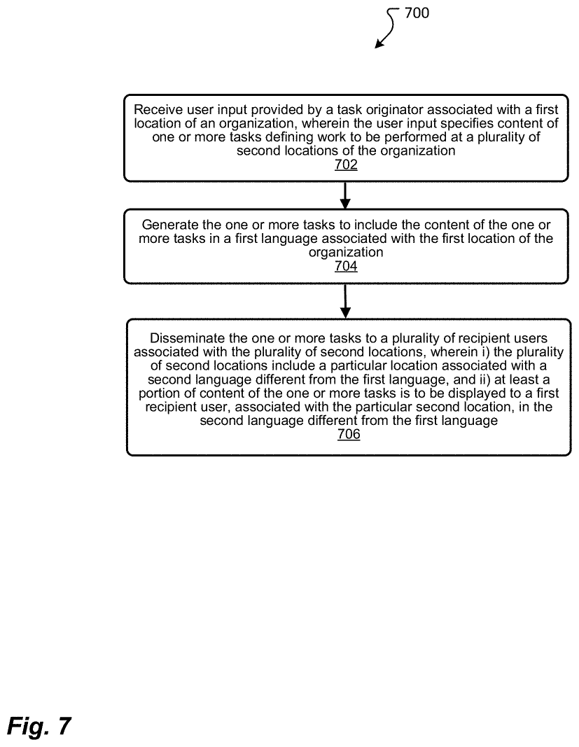

FIG. 7 depicts details of a method 700 for task generation, in accordance with aspects of the present disclosure. A general order for the steps of the method 700 is shown in FIG. 7. The method 700 can be executed as a set of computer-executable instructions executed by a computer system and encoded or stored on a computer readable medium. Further, the method 700 can be performed by gates or circuits associated with a processor, Application Specific Integrated Circuit (ASIC), a field programmable gate array (FPGA), a system on chip (SOC), or other hardware device. Hereinafter, the method 700 shall be explained with reference to the systems, components, modules, software, data structures, user interfaces, etc. described in conjunction with FIGS. 1-6.

At block 702, user input that specifies content of one or more tasks is received. In an aspect, the user input is provided by a task originator associated with a first location of an organization whereas the tasks define work to be performed at a plurality of second locations of an organization. In an aspect, the first location of the organization is a central location, such as a central office or a headquarters of the organization. The plurality of second locations, on the other hand, may be front line locations, such as retail stores, clinics, hospitals, factories, etc. of the organization.

At block 704, the one or more tasks are generated to include the content of the one or more tasks in a first language associated with the first location of the organization. For example, the one or more tasks are generated to include the content in a first language (e.g., English) that is generally spoken at the central location of the organization. In an aspect, generating the one or more tasks comprises generating electronic data that includes at least content of the one or more tasks. In some aspects, the electronic data additionally includes definition of one or fields of the one or more tasks.

At block 706, the one or more tasks are disseminated to a plurality of recipient users associated with the plurality of second locations. For example, electronic data defining the one or more tasks is transmitted to user devices of the one or more recipient users over a network, such as the communication network 108. In an aspect, the plurality of second locations include a particular location associated with a second language different from the first language. In an aspect, to facilitate communication with a task recipient at the particular location, at least a portion of content of the one or more tasks is to be displayed to the task recipient in the second language different from the first language. In an aspect, translation of the at least a portion of content to be displayed to the task recipient in the second language different from the first language is performed automatically and transparently to both the originator of the task and the recipient of the task as described herein. In other aspects, the translation of at least a portion of content to be displayed to the task recipient in the second language different from the first language is performed automatically and transparently to both the originator of the task and the recipient of the task in other suitable manners.

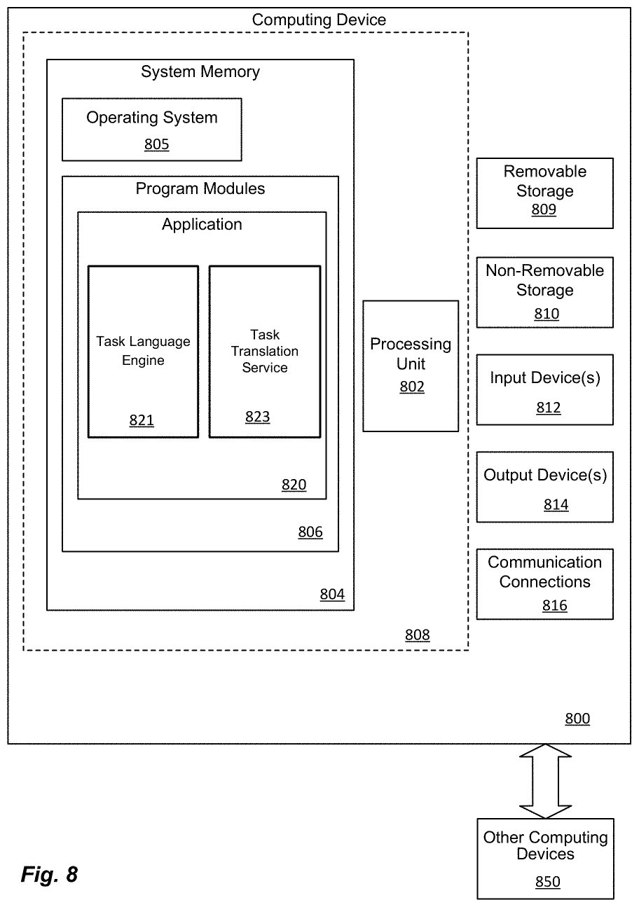

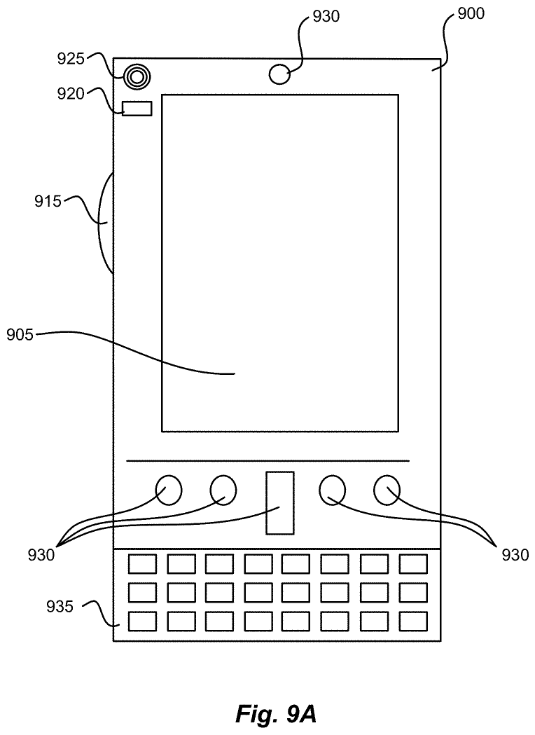

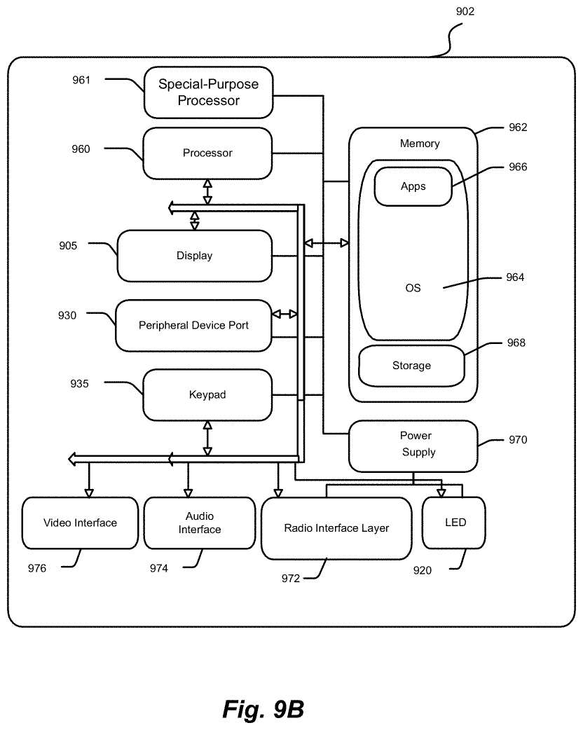

FIGS. 8-9 and the associated descriptions provide a discussion of a variety of operating environments in which aspects of the disclosure may be practiced. However, the devices and systems illustrated and discussed with respect to FIGS. 7-9 are for purposes of example and illustration and are not limiting of a vast number of computing device configurations that may be utilized for practicing aspects of the disclosure, described herein.

FIG. 8 is a block diagram illustrating physical components (e.g., hardware) of a computing device 800 with which aspects of the disclosure may be practiced. The computing device components described below may be suitable for the computing devices described above. In a basic configuration, the computing device 800 may include at least one processing unit 802 and a system memory 804. Depending on the configuration and type of computing device, the system memory 804 may comprise, but is not limited to, volatile storage (e.g., random access memory), non-volatile storage (e.g., read-only memory), flash memory, or any combination of such memories.

The system memory 804 may include an operating system 805 and one or more program modules 806 suitable for running software application 820, such as one or more components supported by the systems described herein. As examples, system memory 804 may store a task language engine 821 (e.g., corresponding to the task language engine 122 of FIG. 1) and/or a translation service 823 (e.g., corresponding to the translation service 121 of FIG. 1). The operating system 805, for example, may be suitable for controlling the operation of the computing device 800.

Furthermore, aspects of the disclosure may be practiced in conjunction with a graphics library, other operating systems, or any other application program and is not limited to any particular application or system. This basic configuration is illustrated in FIG. 8 by those components within a dashed line 808. The computing device 800 may have additional features or functionality. For example, the computing device 800 may also include additional data storage devices (removable and/or non-removable) such as, for example, magnetic disks, optical disks, or tape. Such additional storage is illustrated in FIG. 8 by a removable storage device 809 and a non-removable storage device 810.

As stated above, a number of program modules and data files may be stored in the system memory 804. While executing on the at least one processing unit 802, the program modules 806 (e.g., application 820) may perform processes including, but not limited to, the aspects, as described herein. Other program modules that may be used in accordance with aspects of the present disclosure may include electronic mail and contacts applications, word processing applications, spreadsheet applications, database applications, slide presentation applications, drawing or computer-aided application programs, etc.

Furthermore, aspects of the disclosure may be practiced in an electrical circuit comprising discrete electronic elements, packaged or integrated electronic chips containing logic gates, a circuit utilizing a microprocessor, or on a single chip containing electronic elements or microprocessors. For example, aspects of the disclosure may be practiced via a system-on-a-chip (SOC) where each or many of the components illustrated in FIG. 8 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 800 on the single integrated circuit (chip). Aspects of the disclosure may also be practiced using other technologies capable of performing logical operations such as, for example, AND, OR, and NOT, including but not limited to mechanical, optical, fluidic, and quantum technologies. In addition, aspects of the disclosure may be practiced within a general purpose computer or in any other circuits or systems.

The computing device 800 may also have one or more input device(s) 812 such as a keyboard, a mouse, a pen, a sound or voice input device, a touch or swipe input device, etc. The output device(s) 814 such as a display, speakers, a printer, etc. may also be included. The aforementioned devices are examples and others may be used. The computing device 800 may include one or more communication connections 816 allowing communications with other computing devices 850. Examples of suitable communication connections 816 include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 804, the removable storage device 809, and the non-removable storage device 810 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 800. Any such computer storage media may be part of the computing device 800. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

FIGS. 9A-9B illustrate a mobile computing device 900, for example, a mobile telephone, a smart phone, wearable computer (such as a smart watch), a tablet computer, a laptop computer, and the like, with which aspects of the disclosure may be practiced. In some aspects, the client (e.g., computing system 104A-E) may be a mobile computing device. With reference to FIG. 9A, one aspect of a mobile computing device 900 for implementing the aspects is illustrated. In a basic configuration, the mobile computing device 900 is a handheld computer having both input elements and output elements. The mobile computing device 900 typically includes a display 905 and one or more input buttons 910 that allow the user to enter information into the mobile computing device 900. The display 905 of the mobile computing device 900 may also function as an input device (e.g., a touch screen display). If included, an optional side input element 915 allows further user input. The side input element 915 may be a rotary switch, a button, or any other type of manual input element. In alternative aspects, mobile computing device 900 may incorporate more or less input elements. For example, the display 905 may not be a touch screen in some aspects. In yet another alternative aspect, the mobile computing device 900 is a portable phone system, such as a cellular phone. The mobile computing device 900 may also include an optional keypad 935. Optional keypad 935 may be a physical keypad or a “soft” keypad generated on the touch screen display. In various aspects, the output elements include the display 905 for showing a graphical user interface (GUI), a visual indicator 920 (e.g., a light emitting diode), and/or an audio transducer 925 (e.g., a speaker). In some aspects, the mobile computing device 900 incorporates a vibration transducer for providing the user with tactile feedback. In yet another aspect, the mobile computing device 900 incorporates input and/or output ports, such as an audio input (e.g., a microphone jack), an audio output (e.g., a headphone jack), and a video output (e.g., a HDMI port) for sending signals to or receiving signals from an external source.

FIG. 9B is a block diagram illustrating the architecture of one aspect of computing device, a server, or a mobile computing device. That is, the computing device 900 can incorporate a system (e.g., an architecture) 902 to implement some aspects. The system 902 can implemented as a “smart phone” capable of running one or more applications (e.g., browser, e-mail, calendaring, contact managers, messaging clients, games, and media clients/players). In some aspects, the system 902 is integrated as a computing device, such as an integrated personal digital assistant (PDA) and wireless phone.

One or more application programs 966 may be loaded into the memory 962 and run on or in association with the operating system 964. Examples of the application programs include phone dialer programs, e-mail programs, personal information management (PIM) programs, word processing programs, spreadsheet programs, Internet browser programs, messaging programs, and so forth. The system 902 also includes a non-volatile storage area 968 within the memory 962. The non-volatile storage area 968 may be used to store persistent information that should not be lost if the system 902 is powered down. The application programs 966 may use and store information in the non-volatile storage area 968, such as e-mail or other messages used by an e-mail application, and the like. A synchronization application (not shown) also resides on the system 902 and is programmed to interact with a corresponding synchronization application resident on a host computer to keep the information stored in the non-volatile storage area 968 synchronized with corresponding information stored at the host computer. As should be appreciated, other applications may be loaded into the memory 962 and run on the mobile computing device 900 described herein (e.g., search engine, extractor module, relevancy ranking module, answer scoring module, etc.).

The system 902 has a power supply 970, which may be implemented as one or more batteries. The power supply 970 might further include an external power source, such as an AC adapter or a powered docking cradle that supplements or recharges the batteries.

The system 902 may also include a radio interface layer 972 that performs the function of transmitting and receiving radio frequency communications. The radio interface layer 972 facilitates wireless connectivity between the system 902 and the “outside world,” via a communications carrier or service provider. Transmissions to and from the radio interface layer 972 are conducted under control of the operating system 964. In other words, communications received by the radio interface layer 972 may be disseminated to the application programs 966 via the operating system 964, and vice versa.

The visual indicator 920 may be used to provide visual notifications, and/or an audio interface 974 may be used for producing audible notifications via the audio transducer 925. In the illustrated configuration, the visual indicator 920 is a light emitting diode (LED) and the audio transducer 925 is a speaker. These devices may be directly coupled to the power supply 970 so that when activated, they remain on for a duration dictated by the notification mechanism even though the processor 960 and other components might shut down for conserving battery power. The LED may be programmed to remain on indefinitely until the user takes action to indicate the powered-on status of the device. The audio interface 974 is used to provide audible signals to and receive audible signals from the user. For example, in addition to being coupled to the audio transducer 925, the audio interface 974 may also be coupled to a microphone to receive audible input, such as to facilitate a telephone conversation. In accordance with aspects of the present disclosure, the microphone may also serve as an audio sensor to facilitate control of notifications, as will be described below. The system 902 may further include a video interface 976 that enables an operation of an on-board camera 930 to record still images, video stream, and the like.

A mobile computing device 900 implementing the system 902 may have additional features or functionality. For example, the mobile computing device 900 may also include additional data storage devices (removable and/or non-removable) such as, magnetic disks, optical disks, or tape. Such additional storage is illustrated in FIG. 9B by the non-volatile storage area 968.

Data/information generated or captured by the mobile computing device 900 and stored via the system 902 may be stored locally on the mobile computing device 900, as described above, or the data may be stored on any number of storage media that may be accessed by the device via the radio interface layer 972 or via a wired connection between the mobile computing device 900 and a separate computing device associated with the mobile computing device 900, for example, a server computer in a distributed computing network, such as the Internet. As should be appreciated such data/information may be accessed via the mobile computing device 900 via the radio interface layer 972 or via a distributed computing network. Similarly, such data/information may be readily transferred between computing devices for storage and use according to well-known data/information transfer and storage means, including electronic mail and collaborative data/information sharing systems.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A system comprising:
one or more computer readable storage media; and
program instructions stored on the one or more computer readable storage media that, when executed by at least one processor, cause the at least one processor to:
receive electronic data defining a task that specifies work to be performed at a second location associated with an organization, the electronic data comprising task content specified in a first language at a first location associated with the organization, the electronic data having been transmitted over a communication network;
determine that the first language in which the task content was specified at the first location is different from a second language associated with a recipient of the task at the second location;
in response to determining that the first language is different from the second language, obtain, using an electronic translation engine, translation of at least a portion of the task content from the first language into the second language; and
cause the at least the portion of the task content translated to the second language to be displayed to the recipient.

2. The system of claim 1, wherein the program instructions, when executed by the at least one processor, further cause the at least one processor to determine, based on a profile associated with the recipient of the task, the second language of the recipient of the task.

3. The system of claim 1, wherein
receiving the task comprises receiving the task from a task service hosted on a server; and
the program instructions, when executed by the at least one processor, cause the at least one processor to request the translation from a translation service that is hosted within one or both of i) a security boundary of the task service and ii) a compliance boundary of the task service.

4. The system of claim 1, wherein
the task includes a plurality of fields, and
the program instructions, when executed by the at least one processor, cause the at least one processor to
obtain translation of content of one or more predetermined fields among the plurality of fields of the task, and
cause the content translated to the second language to be displayed within the corresponding one or more fields of the task.

5. The system of claim 4, wherein the program instructions, when executed by the at least one processor, further cause the at least one processor to cause content of one or more additional fields of the task, among the plurality of fields of the task, to be displayed in the first language within the one or more additional fields of the task.

6. The system of claim 5, wherein the one or more predetermined fields include one or more of i) a task title field, ii) a task priority field, iii) a notes field and iv) a checklist field.

7. The system of claim 6, wherein the one or more additional fields include a team name field.

8. The system of claim 1, wherein
the first location in a central office of an organization, and
the second location is one of i) a retail store location ii) a healthcare location and iii) a factory location of the organization.

9. A method for work task generation, the method comprising:
receiving user input provided by a task originator associated with a first location of an organization, wherein the user input specifies content of one or more tasks defining work to be performed at a plurality of second locations of the organization;
generating electronic data defining the one or more tasks, wherein the electronic data includes the content of the one or more tasks in a first language associated with the first location of the organization; and
causing the electronic data defining the one or more tasks to be transmitted, over a communication network, to respective user devices of a plurality of recipient users associated with the plurality of second locations, wherein i) the plurality of second locations include a particular location associated with a second language different from the first language, and ii) at least a portion of content of the one or more tasks is to be displayed to a first recipient user, associated with the particular second location, in the second language different from the first language.

10. The method of claim 9, wherein translation of the at least the portion of the content from the first language to the second language is obtained from a translation services that is hosted as a part of a task server application.

11. The method of claim 9, wherein
the task includes a plurality of fields, and
the at least the portion of the content of the task that is to be displayed to the recipient in the second language includes content of a predetermined subset of the plurality of fields.

12. The method of claim 9, wherein the one or more tasks include a plurality of tasks, wherein respective portions of respective tasks among the plurality of tasks are to be displayed to the first recipient user, associated with the particular second location, in the second language different from the first language.

13. The method of claim 9, wherein
the plurality of locations further include at least one further location associated with a third language different from the first language and from the second language, and
the least the portion of content of the one or more tasks is to further be displayed to a second recipient associated with the further location in the third language different from the first language and from the second language.

14. A computer storage medium storing computer-executable instructions that when executed by at least one processor cause a computer system to:
receive electronic data defining a task that specifies work to be performed at a second location associated with an organization, the electronic data comprising task content specified in a first language at a first location associated with the organization, the electronic data having been transmitted over a communication network;
determine that the first language in which the task content was specified at the first location is different from a second language associated with a recipient of the task at the second location;
in response to determining that the first language is different from the second language, obtain, using an electronic translation engine, translation of at least a portion of the task content from the first language into the second language; and
cause the at least the portion of the task content translated to the second language to be displayed to the recipient.

15. The computer storage medium of claim 14, wherein the instructions, when executed by the at least one processor, further cause the computer system to determine, based on a profile associated with the recipient of the task, the second language of the recipient of the task.

16. The computer storage medium of claim 14, wherein the instructions, when executed by the at least one processor, further cause the computer system to
receive the task from a task service hosted on a server; and
cause the at least one processor to request the translation from a translation service that is hosted within one or both of i) a security boundary of the task service and ii) a compliance boundary of the task service.

17. The computer storage medium of claim 14, wherein
the task includes a plurality of fields, and
the instructions, when executed by the at least one processor, further cause the computer system to
obtain translation of content of one or more predetermined fields among the plurality of fields of the task, and
cause the content translated to the second language to be displayed within the corresponding one or more fields of the task.

18. The computer storage medium of claim 17, wherein the program instructions, when executed by the at least one processor, further cause the computer system to cause content of one or more additional fields of the task, among the plurality of fields of the task, to be displayed in the first language within the one or more additional fields of the task.

19. The computer storage medium of claim 17, wherein the one or more predetermined fields include one or more of i) a task title field, ii) a task priority field, iii) a notes field and iv) a checklist field.

20. The computer storage medium of claim 17, wherein
the first location in a central office of an organization, and
the second location is one of i) a retail store location ii) a healthcare location and iii) a factory location of the organization.
